(19) United States
(12) Patent Application Publication
(10) Pub. No.: US 2008/0120317 A1
(43) Pub. Date: May 22, 2008

(54) Language processing system

(76) Inventors: Bradley P. Gile, Dunlap, IL (US); Seth A. Johnsen, Metamora, IL (US); Jennifer L. Crompton, Morton, IL (US); Barbara J. Church, East Peoria, IL (US); Brad Shapland, Metamora, IL (US); Ma Jun, Shanghai (CN); Jeremy Moza, Morton, IL (US); Anu Thomas, Peoria, IL (US); Jason Thompson, Washington, IL (US)

Correspondence Address: CATERPILLAR/FINNEGAN, HENDERSON, L.L.P., 901 New York Avenue, NW, WASHINGTON, DC, 20001-4413, US

(21) Appl. No.: 11/602,339

(22) Filed: Nov. 21, 2006

(51) Int. Cl. G06F 17/20

(52) U.S. Cl. 707/101

(57) ABSTRACT

A language processing system is provided, including at least one computer-readable medium having stored thereon instructions for performing a method. The method may include retrieving a first body of alphanumeric character-based text from a first database. The method may also include converting the first body of alphanumeric character-based text into a multi-bit character encoding. In addition, the method may include writing the multi-bit encoded text to a non-formatted text file and storing the multi-bit encoded text from the text file in a second database. Further, the method may include converting the multi-bit encoded text in the second database to a set of hexidecimal codes and creating, from the set of hexidecimal codes, a web-based report that reproduces the first body of alphanumeric character-based text.

### TECHNICAL FIELD

The present disclosure is directed to a language processing system and, more particularly, to a language processing system configured to transfer alphanumeric character-based text from a database to a web-based report.

### BACKGROUND

In international communication, it is often desired and/or required to provide documents or portions of documents in multiple languages. Conversion of text to encoding that is readily manageable and transferable electronically can be challenging, particularly for languages with complex character sets, such as, for example, Asian languages. For example, languages with simpler characters, like English, are readily convertible to encoding in which each character requires one byte (i.e., 8 bits) of memory. By contrast, more complex character sets, such as Asian languages, may require nearly four bytes (i.e., 32 bits) of memory for each character.

Character encodings (i.e., character sets) have been developed that include sufficient memory for each character to represent complex characters, such as those used by Asian languages. An example of such a character encoding is Unicode. In particular, one type of Unicode, UTF-8, is a 32-bit wide character encoding, capable of storing Asian language characters for electronic storage and/or transfer.

Various multi-lingual record processing systems have been developed. U.S. Pat. No. 6,757,688, to Leapaldt et al. (“the '688 patent”), discloses an enhancement for multi-lingual record processing. The '688 patent discloses a system that translates all information in a database into Unicode, thereby providing a single uniform database into which mixed language records can be stored.

While the '688 patent discloses a system for providing a single uniform database for multiple language records, the '688 patent utilizes a more complex encoding (e.g., Unicode) not only for complex character sets, but also even for simple character sets, rather than utilizing a less complex encoding (e.g., ASCII) to encode simple character sets. In addition, the '688 patent does not disclose any methodology for converting the information stored in the single uniform database to a web-based report.

The present disclosure is directed at solving one or more of the problems discussed above.

### SUMMARY OF THE INVENTION

In one aspect, the present disclosure is directed to a language processing system including at least one computer-readable medium having stored thereon instructions for performing a method. The method may include retrieving a first body of alphanumeric character-based text from a first database. The method may also include converting the first body of alphanumeric character-based text into a multi-bit character encoding. In addition, the method may include writing the multi-bit encoded text to a non-formatted text file and storing the multi-bit encoded text from the text file in a second database. Further, the method may include converting the multi-bit encoded text in the second database to a set of hexidecimal codes and creating, from the set of hexidecimal codes, a web-based report that reproduces the first body of alphanumeric character-based text.

In another aspect, the present disclosure is directed to a method of language processing. The method may also include retrieving a first body of alphanumeric character-based text from a first database. The method may include converting the first body of alphanumeric character-based text into a multi-bit character encoding (e.g., UTF-8) and writing the multi-bit encoded text to a non-formatted text file. The method may further include storing the multi-bit encoded text from the text file in a second database. In addition, the method may include converting the multi-bit encoded text in the second database to a first set of hexidecimal codes and creating, from the first set of hexidecimal codes, a web-based report that reproduces the first body of alphanumeric character-based text.

### BRIEF DESCRIPTION OF THE DRAWINGS

FIG. 1 is a diagrammatic representation of a language processing system according to an exemplary disclosed embodiment.

FIG. 2 is a flow chart illustrating aspects of a language processing method according to an exemplary disclosed embodiment.

### DETAILED DESCRIPTION

Reference will now be made in detail to the drawings. Wherever possible, the same reference numbers will be used throughout the drawings to refer to the same or like parts.

It should also be noted that, for purposes of this disclosure, the term “alphanumeric” shall refer to any and all characters that may be used for written communication in any language. For example, alphanumeric characters, as referred to herein, may include characters, such as letters and numbers, and also punctuation. Alphanumeric characters may also include various symbols that may be used in written text, such as @, #, $, &, *, etc., and/or other symbols that may be used in non-English languages.

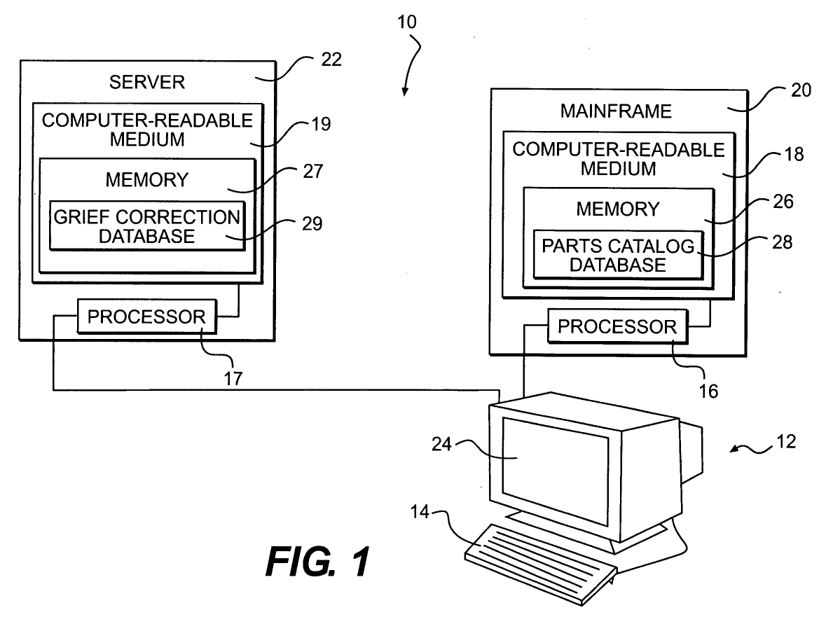

FIG. 1 illustrates a block diagram of an exemplary language processing system 10. FIG. 1 illustrates an exemplary set of hardware components that may be configured to perform the language processing disclosed herein. For example, system 10 may include a display device 12, an input device 14, a processor 16, 17, and at least one computer-readable medium (18, 19) operatively coupled to processor 16 and having stored thereon instructions for performing methods as will be described in detail below. System 10 may also include a mainframe 20 and/or a server 22. As shown in FIG. 1, either or both of mainframe 20 and server 22 may include components such as processor 16, 17, computer-readable media 18, 19, a memory 26, 27, and/or a database 28, 29. While system 10 may include a number of various components, as illustrated in FIG. 1, in some embodiments, system 10 may include a select few components. In some embodiments, system 10 may include a single component (e.g., a computer-readable medium having particular instructions stored thereon).

Display device 12 may include any type of display equipment configured to provide visual feedback regarding system 10 and its components and functions. Display device 12 may include any of a number of screen type displays, such as, for example, a cathode ray tube (CRT) as shown in FIG. 1, a liquid crystal display (LCD), a plasma screen, or the like. Display device 12 may be configured to display an input interface 24. Input interface 24 may be displayed in any format suitable for accepting data entry. Display device 12 may also provide other information regarding any other device and/or system associated with system 10. System 10 may be Internet-based and, as such, input interface 24 may be displayed by display device 12 as one or more web pages available on a local or global network.

Input device 14 may include any type of devices suitable for inputting data and/or navigating through screens/menus that may be displayed by display device 12. For example, input device 14 may include a keyboard (as shown in FIG. 1), mouse, etc. In some embodiments, input device 14 may be at least partially integrated with display device 12. In such embodiments, display device 12 may include, for example, a touch screen.

Although system 10 is illustrated as including a desktop computer, wherein display device 12 includes a CRT monitor, system 10 may alternatively or additionally include a portable, and in some cases, handheld unit (not shown). Exemplary portable or handheld units may include laptops, personal data assistants (PDAs), or other devices distinctly designed for use with system 10.

Computer-readable medium 18 and computer readable medium 19 may each include any type of computer-readable medium including, for example, computer chips and secondary storage devices, including hard disks, floppy disks, optical media, CD-ROM, or other forms of RAM or ROM. Computer-readable medium 18 may include memory 26 in which may be stored instructions for performing a language processing method or aspects of a language processing method. Memory 26 or another memory may include database 28 stored thereon.

Database 28 may contain data in any format. In some embodiments, database 28 may be a parts catalog type database. One exemplary database that may be used for database 28 may include DB2. Database 28 may include any type of information, in any language or languages. In one embodiment, database 28 may include a spreadsheet including information about products, equipment, or parts for such products or equipment (e.g., replacement parts for vehicles or other machines). For example, this information may include part numbers, harmonized tarriff schedule codes (HTS codes), and multi-lingual part descriptions. In one embodiment, the spreadsheet may include both English and corresponding Chinese (or other Asian language) and/or Russian part descriptions for each part.

Computer-readable medium 19 may include memory 27 in which may be stored instructions for performing a language processing method or aspects of a language processing method. Memory 27 or another memory may include a database 29 stored thereon. Database 29 may contain data in any format, including, for example, word processing files (e.g., Microsoft Word documents) or spreadsheets (e.g., Microsoft Excel spreadsheets). For purposes of discussion, the present disclosure will describe utilization of a spreadsheet format for database 29. In some embodiments, database 29 may be a grief correction database, which will be described in greater detail below.

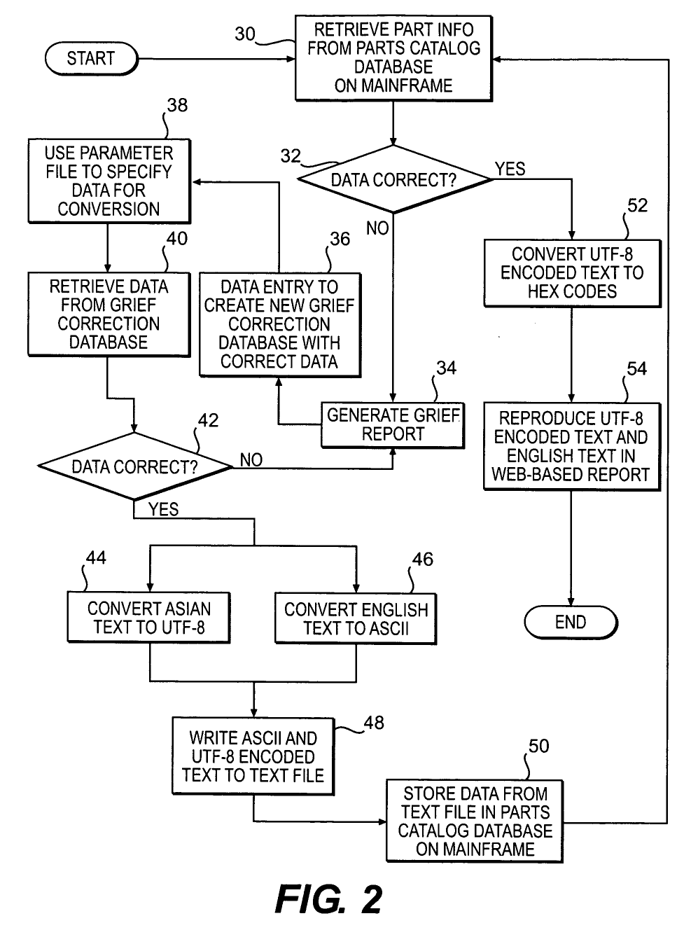

FIG. 2 illustrates an exemplary language processing method for which computer-readable medium 18, 19 may include instructions. In some embodiments, one or more aspects of the illustrated method may be performed by a user (e.g., data entry). The language processing method may be initiated with an attempt to retrieve text data from database 28 (step 30). For example, upon shipping a container of parts, a user may make input to system 10 to request shipping documentation. Some of the shipping documentation may be for importation in a foreign country (e.g., customs clearance in a destination country). Therefore, parts information may be retrieved from a parts catalog database (e.g., database 28).

Upon attempting to retrieve such data, system 10 may determine if any of the data sought is missing, incorrect, or incomplete (step 32). If any of the data is missing, incorrect, or incomplete, a grief report may be generated (step 34), which indicates which data is missing, incorrect, or incomplete. A user of system 10 may, upon receipt of the grief report, enter correct data into system 10 and, thereby, create a grief correction database (e.g., database 29), including correct data for any data that was identified as missing, incorrect, or incomplete. (Step 36)

In some embodiments, a parameter file may be used to specify which data (e.g., columns and/or rows) of database 29 is to be converted (step 38). A first body of alphanumeric character-based text may be retrieved from (grief correction) database 29 using a first software module (step 40). The first software module may be written in any suitable language, such as, for example, Java. As in step 32, the presence and accuracy of the data may be checked at step 42.

As shown in FIG. 2, the method may include converting the first body of alphanumeric character-based text (e.g., an Asian language part description from database 28) into a multi-bit character encoding (step 44). The multi-bit character encoding may be any suitable encoding. For example, a Unicode character set, such as UTF-8, may be used to encode the first body of alphanumeric character-based text. Depending on the language intended to be processed, and the complexity of its characters, various encodings may be suitable. For example, a 24-bit encoding may be sufficient to encode moderately complex characters, while a 32-bit encoding may be more appropriate for other languages having more complex characters.

In addition, the method performed by the first software module may include converting (e.g., using the first software module) a second body of alphanumeric character-based text (e.g., an English language version of the Asian language part description referred to above) into ASCII encoding (step 46). The second body of alphanumeric character-based text may be any ASCII writable text, i.e., any language or portions of a language including only ASCII characters.

The first software module may also retrieve any other data from database 28 (step 40), such as, for example, part numbers, HTS codes, etc., and convert the data to a non-formatted text, e.g., ASCII. Each of these other types of data may be processed in much the same way as the afore-mentioned second body of alphanumeric character-based text.

The method performed by the first software module may also include writing the multi-bit encoded text to a non-formatted text file (step 48), e.g., in ASCII, and storing the text file in a memory, such as memory 26. For example, a UTF-8 encoding for a given character may be a series of numbers, letters, and/or symbols (i.e., ASCII characters). This series of ASCII characters may be written to a non-formatted text file (i.e., in ASCII). Because of the simplicity of a non-formatted text file, the created text file may be stored on virtually any system, including, for example, mainframe 20, which, in some embodiments, may otherwise be incapable of storing and/or processing complex characters, such as Asian text, Russian text, or any other language including non-ASCII characters. In other words, the non-formatted text representation of multi-bit encoded text may provide a mechanism by which complex characters, such as Asian text, may be stored on a system (e.g., a mainframe) that may otherwise be incapable of storing such complex characters.

Therefore, a single text file may include both Asian and non-Asian language versions of a part description, wherein both versions are similarly encoded (e.g., the English text may be in ASCII and the UTF-8 encoded Asian text may be written in ASCII encoding).

The text file may be sent to mainframe 20 or other destinations via File Transfer Protocol (FTP). A separate module, such as a Cobol program, may be stored on mainframe 20 and may process the text file in order to store the data from the text file into database 28 (step 50). The Asian characters may be stored in VARCHAR fields in UTF-8 encoding.

Once the grief correction data has been transferred to mainframe 20 to update database 28, the retrieval of part info from database 28 may be attempted again (step 30). The presence and accuracy of data in database 28 may be checked once again (step 32). If any of the data is missing, incorrect, or incomplete, a grief report may be generated (step 34) and the correction process described above (or another suitable correction process) may be completed.

Using the same or a separate software module or modules (e.g., Cobol programs, which may be stored on mainframe 20), the method may further include converting the multi-bit encoded text to a set of hexidecimal codes (step 52). The method may include creating, from the set of hexidecimal codes, a web-based report that reproduces (i.e., displays) the first body of alphanumeric character-based text as stored in database 28 (step 54). Creating the web-based report (step 54) may also include writing the ASCII encoding of the second body of alphanumeric character-based text.

The web-based report may be produced using any suitable programming language, such as, for example, HTML. In some embodiments, the HTML report may be stored with an HTML document type on a document server for easy retrieval and distribution. A local or remote user of system 10 may view and/or print the HTML report via a web browser.

If separate software modules are employed, the modules may be stored on the same or different computer-readable media (e.g., the modules may be stored in the same memory or different memories). Therefore, in such embodiments, there may be two or more sets of instructions that, together, make up the complete instructions for performing the method. For example, a first set of instructions may include the instructions for the steps of converting a first body of alphanumeric character-based text into a multi-bit character encoding and writing the multi-bit encoded text to a non-formatted text file. A second set of instructions may include the instructions for the steps of converting the multi-bit encoded text to a first set of hexidecimal codes and creating, from the first set of hexidecimal codes, a web-based report that reproduces the first body of alphanumeric character-based text.

System 10 is shown and described herein to include various hardware and software components associated with each other in one or more ways. However, any of the disclosed modules, memories, databases, etc., may be stored in, and/or executed by, any of the hardware components described herein in any of a number of ways to achieve the disclosed language processing functions.

### INDUSTRIAL APPLICABILITY

The disclosed system may be applicable to language processing in any context. In some embodiments, the disclosed system may be applicable to international shipping management. For example, some international shippers may desire or may be required to include multi-lingual versions of their shipping documentation. Using the disclosed system, shipping documentation may be provided to receiving parties in destination countries, in order to facilitate customs clearance in the destination country. Some countries require Customs documentation to include certain information to be furnished in the native language of the country. For example, China Customs may require product descriptions to be provided in Chinese text. The disclosed system may facilitate language processing to enable the production of Customs documentation that complies with such requirements.

The disclosed system and the software modules employed, may enable or facilitate language processing using less sophisticated equipment and software. For example, the disclosed system may enable complex character languages (e.g., languages including non-ASCII characters, such as Asian languages) to be stored and/or processed by a mainframe, which may not have such a capability without preliminary processing of the text. As such, utilization of one or more components and/or modules of the disclosed system may provide a user with the capability of processing complex languages without having to update/replace software and/or hardware components of the computing system, which can be expensive and/or time consuming. In some situations, for example, a corporation who has made substantial investments in a given computing system (i.e., hardware and/or software), may need years (not months) to update that system. The presently disclosed language processing method may enable such corporations to have the capability of processing complex languages until suitable updates can be made to the computing system.

In addition, by converting and storing complex characters in a widely-supported multi-bit encoding, such as UTF-8, the encoded text may be readily decoded by a broad range of software applications and/or operating systems. Therefore, UTF-8 encoded text may be readily transferred and/or decoded upon upgrades to software/operating systems. For example, the disclosed system may be implemented to provide complex language processing capabilities to a mainframe running an operating system that does not otherwise provide such capabilities. Upon upgrading to an operating system that is capable of processing complex characters, the data previously stored in UTF-8 encoded format, may be readily converted to the complex characters, which may be processed by the upgraded operating system.

The disclosed system may be used to perform a method of language processing. One exemplary such method may include retrieving a first body of alphanumeric character-based text from a first database. The method may also include converting the first body of alphanumeric character-based text into a multi-bit character encoding (e.g., UTF-8) and writing the multi-bit encoded text to a non-formatted text file. The method may also include storing the multi-bit encoded text from the text file in a second database. In addition, the method may include converting the multi-bit encoded text in the second database to a first set of hexidecimal codes and creating, from the first set of hexidecimal codes, a web-based report that reproduces the first body of alphanumeric character-based text. In some embodiments, the web-based report may be produced using HTML.

The method may also include retrieving a second body of alphanumeric character-based text from the first database and converting the second body of alphanumeric character-based text into ASCII encoding and writing the ASCII encoded text to the non-formatted text file. The method may include storing the ASCII encoded text from the text file in the second database and writing the ASCII encoded text stored in the second database into the web-based report.

In some embodiments, the first body of alphanumeric character-based text may include text written in a language that includes non-ASCII characters and the second body of alphanumeric character-based text may include only ASCII characters.

In some embodiments, the method may be described with two or more sets of instructions stored on at least one computer-readable medium. In such embodiments, a first set of instructions may include the instructions for the steps of retrieving a first body of alphanumeric character-based text from a first database, converting the first body of alphanumeric character-based text into a multi-bit character encoding, writing the multi-bit encoded text to a non-formatted text file, and storing the multi-bit encoded text from the text file in a second database. Also, in such embodiments, a second set of instructions may include the instructions for the steps of converting the multi-bit encoded text in the second database to a first set of hexidecimal codes, and creating, from the first set of hexidecimal codes, a web-based report that reproduces the first body of alphanumeric character-based text. In some embodiments, each of the two or more sets of instructions may be stored on a separate computer-readable medium.

The method may further include checking the second database to determine if any data is missing, incorrect, or incomplete. The method may also include generating a grief report identifying any missing, incorrect, or incomplete data. In addition, the method may include generating the first database based on the grief report by inputting correct information for data that was identified in the grief report as missing, incorrect, or incomplete.

It should be noted that, although separate software modules are discussed for various aspects of the disclosed methods, these methods could be performed by any number of modules. Alternatively, it is contemplated that, in some embodiments, a single module may be utilized to perform all aspects of the disclosed language processing functions.

It will be apparent to those having ordinary skill in the art that various modifications and variations can be made to the disclosed language processing system without departing from the scope of the invention. Other embodiments of the invention will be apparent to those having ordinary skill in the art from consideration of the specification and practice of the invention disclosed herein. It is intended that the specification and examples be considered as exemplary only, with a true scope of the invention being indicated by the following claims and their equivalents.

What is claimed is:

1. A language processing system, comprising:
at least one computer-readable medium having stored thereon instructions for performing a method including:
retrieving a first body of alphanumeric character-based text from a first database;
converting the first body of alphanumeric character-based text into a multi-bit character encoding;
writing the multi-bit encoded text to a non-formatted text file;
storing the multi-bit encoded text from the text file in a second database;
converting the multi-bit encoded text in the second database to a set of hexadecimal codes; and
creating, from the set of hexidecimal codes, a web-based report that reproduces the first body of alphanumeric character-based text.

2. The system of claim 1, wherein the multi-bit character encoding is UTF-8.

3. The system of claim 1, wherein the web-based report is produced using HTML.

4. The system of claim 1, wherein the method further includes:
retrieving a second body of alphanumeric character-based text from the first database; and
converting the second body of alphanumeric character-based text into ASCII encoding and writing the ASCII encoded text to the non-formatted text file.

5. The system of claim 4, wherein the method further includes:
storing the ASCII encoded text from the text file in the second database; and
writing the ASCII encoded text stored in the second database into the web-based report.

6. The system of claim 5, wherein the first body of alphanumeric character-based text includes text written in a language that includes non-ASCII characters and the second body of alphanumeric character-based text includes only ASCII characters.

7. The system of claim 1, wherein the instructions are part of two or more sets of instructions;
wherein a first set of instructions includes the instructions for the steps of:
retrieving a first body of alphanumeric character-based text from a first database;
converting the first body of alphanumeric character-based text into a multi-bit character encoding;
writing the multi-bit encoded text to a non-formatted text file; and
storing, in a second database, the multi-bit encoded text from the text file; and
wherein a second set of instructions includes the instructions for the steps of:
converting the multi-bit encoded text in the second database to a set of hexidecimal codes; and
creating, from the set of hexidecimal codes, a web-based report that reproduces the first body of alphanumeric character-based text.

8. The system of claim 1, wherein each of the two or more sets of instructions is stored on a separate computer-readable medium.

9. The system of claim 1, wherein the method further includes:
checking the second database to determine if any data is missing, incorrect, or incomplete; and
generating a grief report identifying any missing, incorrect, or incomplete data.

10. The system of claim 9, wherein the first database is generated based on the grief report and includes correct information for data that was identified as missing, incorrect, or incomplete.

11. A method of language processing, comprising:
retrieving a first body of alphanumeric character-based text from a first database;
converting the first body of alphanumeric character-based text into a multi-bit character encoding;
writing the multi-bit encoded text to a non-formatted text file;
storing the multi-bit encoded text from the text file in a second database;
converting the multi-bit encoded text in the second database to a first set of hexidecimal codes; and
creating, from the first set of hexidecimal codes, a web-based report that reproduces the first body of alphanumeric character-based text.

12. The method of claim 11, wherein the multi-bit character encoding is UTF-8.

13. The method of claim 11, wherein the web-based report is produced using HTML.

14. The method of claim 11, further including:
retrieving a second body of alphanumeric character-based text from the first database; and
converting the second body of alphanumeric character-based text into ASCII encoding and writing the ASCII encoded text to the non-formatted text file.

15. The method of claim 14, further including:
storing the ASCII encoded text from the text file in the second database; and
writing the ASCII encoded text stored in the second database into the web-based report.

16. The method of claim 15, wherein the first body of alphanumeric character-based text includes text written in a language that includes non-ASCII characters and the second body of alphanumeric character-based text includes only ASCII characters.

17. The method of claim 11, wherein the method is described with two or more sets of instructions stored on at least one computer-readable medium;
wherein a first set of instructions includes the instructions for the steps of:
retrieving a first body of alphanumeric character-based text from a first database;
converting the first body of alphanumeric character-based text into a multi-bit character encoding;
writing the multi-bit encoded text to a non-formatted text file; and
storing the multi-bit encoded text from the text file in a second database; and
wherein a second set of instructions includes the instructions for the steps of:
converting the multi-bit encoded text in the second database to a first set of hexidecimal codes; and
creating, from the first set of hexidecimal codes, a web-based report that reproduces the first body of alphanumeric character-based text.

18. The method of claim 17, wherein each of the two or more sets of instructions is stored on a separate computer-readable medium.

19. The method of claim 11, further including:
checking the second database to determine if any data is missing, incorrect, or incomplete; and
generating a grief report identifying any missing, incorrect, or incomplete data.

20. The method of claim 19, further including generating the first database based on the grief report by inputting correct information for data that was identified in the grief report as missing, incorrect, or incomplete.
